(19) United States
(12) Patent Application Publication
(10) Pub. No.: US 2024/0413416 A1
(43) Pub. Date: Dec. 12, 2024

(54) BATTERY CELL MONITORING

(71) Applicant: VOLVO TRUCK CORPORATION, GÖTEBORG (SE)

(72) Inventors: Youngjin CHOI, Västra Frölunda (SE); Sophie TINTIGNAC, GÖTEBORG (SE); Alice HAMRIN, GÖTEBORG (SE); Gustav GISKE, JOHANNESHOV (SE)

(21) Appl. No.: 18/733,269

(22) Filed: Jun. 4, 2024

(30) Foreign Application Priority Data
Jun. 9, 2023 (EP) 23178360.6

(51) Int. Cl. H01M 10/48; B60L 3/00; B60L 3/04; G01B 21/32; H01M 50/342; H01M 50/574

(52) U.S. Cl. CPC H01M 10/48; B60L 3/0046; B60L 3/04; G01B 21/32; H01M 50/3425; H01M 50/574; H01M 2200/20; H01M 2220/20

(57) ABSTRACT

A system for monitoring a battery cell, the system comprising a deformation detector configured to be arranged at a distance from a vent portion of the battery cell when the vent portion is in a non-deformed position and configured to detect a deformation of the vent portion; and processing circuitry for determining if the detected deformation meets a threshold deformation.

### CROSS REFERENCE TO RELATED APPLICATION

This application claims foreign priority to European Application 23178360.6 filed on Jun. 9, 2023, the disclosure and content of which is incorporated by reference herein in its entirety.

### TECHNICAL FIELD

The disclosure relates generally to battery cells. In particular aspects, the disclosure relates to battery cell monitoring, in particular systems and methods for predicting venting of a battery cell. The disclosure can be applied to heavy-duty vehicles, such as trucks, buses, and construction equipment, among other vehicle types. The disclosure can also be applied to marine vessels, such as water crafts, motorboats, work boats, sport vessels, boats, ships, among other vessel types. The disclosure can also be applied to test environments for batteries.

Although the disclosure may be described with respect to a particular implementation, the disclosure is not restricted to any particular implementation.

### BACKGROUND

Battery electric vehicles serve as an environmentally sustainable alternative to combustion engines that run on fossil fuels. Several companies in the heavy vehicle industry aim to reach a point in the near future where they only sell and produce vehicle combinations that use electrical power as the main source of propulsion. In battery electric vehicles, batteries are installed to power electric motors and provide propulsion. Rechargeable batteries are therefore becoming more and more prevalent in the automotive industry.

There are three principal types of battery cell that are used in rechargeable battery packs for vehicles: cylindrical cells, prismatic cells, and pouch cells. Such battery cells must be safe to use. To achieve this, some rechargeable battery cells have one or more vents. A vent is a mechanical part of the cap assembly of a battery that enables the release of gases and other material from inside the battery when the pressure inside the battery rises above an allowed level. This ensures catastrophic failure of the battery cell is prevented.

However, in many cases, hazardous or toxic material, such as methine group gases, carbonyl group gases, hydrogen fluoride, and the like, is released from the cell during venting. This means that other components of the battery pack can be contaminated or damaged by released material. For example, in a lithium-ion battery, residual lithium salts, e.g. LiPF6, included in the electrolyte of the battery cell can react with moisture in the atmosphere to form hydrogen fluoride, leading to corrosion of mechanical parts of the battery pack. Even in the case of cell testing, where a battery cell is kept in a climate chamber, toxic material can be released and contaminate or damage the chamber itself.

It is therefore desired to develop a solution for battery cell venting that addresses or at least mitigates some of these issues.

### SUMMARY

This disclosure attempts to address the problems noted above by providing systems, methods and other approaches for monitoring vent deformation throughout the life span of a battery cell to protect battery packs and test facilities from cell venting. By monitoring the deformation of a cell vent, early detection of potential cell venting can be provided, as opposed to current sensing methods that focus on detecting cell venting events after they have occurred. This approach enables action to be taken before venting, ensuring that contamination or damage of the surroundings of the cell can be avoided.

According to an aspect of the disclosure, there is provided a system for monitoring a battery cell, the system comprising a deformation detector configured to be arranged at a distance from a vent portion of the battery cell when the vent portion is in a non-deformed position and configured to detect a deformation of the vent portion, and processing circuitry for determining if the detected deformation meets a threshold deformation.

This enables early detection of potential cell venting, which ensures that action can be taken before potentially dangerous material is discharged from the cell and causes damage or contamination of the surrounding environment, for example parts of a battery pack or test facility. By implementing a deformation detector arranged at a distance from a vent portion, the monitoring can be performed without interfering with the structure of the vent portion and hindering its primary safety function.

Optionally, the deformation detector comprises at least one contact sensor configured to contact the vent portion when the vent portion is in a deformed position. This provides a simple mechanism for detecting deformation of the vent portion.

Optionally, the at least one contact sensor is disposed in a cantilevered arrangement. This enables the arrangement of a deformation detector that does not interfere with the structure of the vent portion.

Optionally, the at least one contact sensor is disposed in a cantilevered arrangement from a housing of the battery cell. This provides an integrated design for a battery cell that enables early detection of potential cell venting without interfering with the structure and function of the vent portion.

Optionally, the distance corresponds to the threshold deformation. This provides a simple structure for instantly detecting a threshold deformation.

Optionally, the deformation detector comprises at least one non-contact sensor configured to detect a deformation of the vent portion. This enables the arrangement of a deformation detector that does not interfere with the structure and function of the vent portion.

Optionally, the non-contact sensor comprises an optical sensor or a laser sensor. This enables different devices to be used, for example in implementations requiring different levels of precision.

Optionally, the deformation detector comprises a plurality of sensors. This enables the deformation to be determined at a number of positions of the vent portion, providing more reliable detection.

Optionally, the threshold deformation corresponds to a deformation of the vent portion less than a deformation required for venting of the battery cell. This enables early detection of potential cell venting, which ensures that action can be taken before potentially dangerous material is discharged from the cell and causes damage or contamination of surrounding parts of a battery pack or test facility.

Optionally, the threshold deformation is determined based on experimental or model data. This enables thresholds to be determined accurately for specific use cases.

Optionally, the threshold deformation comprises a plurality of threshold deformations. This enables different parts of the vent portion to undergo different levels of deformation before an action is taken.

Optionally, the vent portion is provided on an end side of the battery cell comprising one or more electrical terminals. This enables venting of the battery cell to be directed in a particular direction, for example away from sensitive components.

Optionally, the battery cell is a prismatic cell, a cylindrical cell, or a pouch cell. This enables early detection of potential cell venting in a number of different types of cell.

Optionally, the battery cell is comprised in a battery pack for a vehicle. This enables components of a battery pack and a vehicle to be protected through detection of cell venting.

According to an aspect of the disclosure, there is provided vehicle comprising the system.

Optionally, the battery cell is in a test environment. This enables components of a test environment to be protected through detection of cell venting.

According to an aspect of the disclosure, there is provided a method for monitoring a battery cell, the method comprising determining a deformation of a vent portion of the battery cell at a deformation detector arranged at a distance from a vent portion, and determining if the detected deformation meets a threshold deformation.

This enables early detection of potential cell venting, which ensures that action can be taken before potentially dangerous material is discharged from the cell and causes damage or contamination of surrounding parts of a battery pack or test facility. This can be performed without interfering with the structure of the vent portion and hindering its primary safety function.

Optionally, the method comprises determining the deformation using at least one contact sensor of the deformation detector. This provides a simple mechanism for detecting deformation of the vent portion.

Optionally, the method comprises determining the deformation using at least one non-contact sensor of the deformation detector. This enables early detection of potential cell venting without interfering with the structure and function of the vent portion.

Optionally, the method further comprises taking an action to prevent venting of the battery cell in response to determining that the detected deformation meets the threshold deformation. This enables surrounding parts of a battery pack or test facility to be protected as discharge of potentially dangerous material can be prevented.

Optionally, taking an action comprises electrically disconnecting the battery cell. This enables venting to be prevented, thus protecting surrounding parts of a battery pack or test facility from discharge of potentially dangerous material.

According to an aspect of the disclosure, there is provided a computer-implemented method comprising, by processing circuitry of a computer system, receiving a signal representing a deformation of a vent portion of the battery cell from a deformation detector arranged at a distance from a vent portion, and determining if the detected deformation meets a threshold deformation.

This enables early detection of potential cell venting, which ensures that action can be taken before potentially dangerous material is discharged from the cell and causes damage or contamination of surrounding parts of a battery pack or test facility. This can be performed without interfering with the structure of the vent portion and hindering its primary safety function.

Optionally, the computer-implemented method further comprises taking an action to prevent venting of the battery cell in response to determining that the detected deformation meets the threshold deformation, for example sending a signal to electrically disconnect the battery cell. This enables surrounding parts of a battery pack or test facility to be protected as discharge of potentially dangerous material can be prevented.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above-discussed technical benefits.

### BRIEF DESCRIPTION OF THE DRAWINGS

With reference to the appended drawings, below follows a more detailed description of aspects of the disclosure cited as examples.

FIGS. 1A to 1C illustrate example battery cells.

FIGS. 2A to 2C schematically show cross-sectional views of an example battery cell undergoing venting.

FIG. 3 schematically shows an example system for monitoring a battery cell.

FIGS. 4A and 4B schematically show cross-sectional views of an example deformation detector of a system for monitoring a battery cell.

FIGS. 5A and 5B schematically show cross-sectional views of another example deformation detector of a system for monitoring a battery cell.

FIGS. 6A and 6B schematically show cross-sectional views of another example deformation detector of a system for monitoring a battery cell.

FIGS. 7A and 7B schematically show cross-sectional views of another example deformation detector of a system for monitoring a battery cell.

FIGS. 8A to 8C schematically show cross-sectional views of another example deformation detector of a system for monitoring a battery cell.

FIG. 9 is a flow chart of an example method for monitoring a battery cell.

FIG. 10 is a flow chart of an example computer-implemented method for monitoring a battery cell.

FIG. 11 is a schematic diagram of a computer system for implementing examples disclosed herein.

Like reference numerals refer to like elements throughout the description.

### DETAILED DESCRIPTION

Aspects and examples set forth below represent the necessary information to enable those skilled in the art to practice the disclosure.

Many present day battery cells include one or more vents for releasing pressure inside the battery when it rises above an allowed level. This ensures catastrophic failure of the battery cell is prevented. However, cell venting can result in hazardous or toxic material being released from the cell, meaning that surrounding components can be contaminated or damaged. To remedy this, systems, methods and other approaches are provided for monitoring

vent deformation throughout the life span of a battery cell. By monitoring the shape or deformation of a cell vent early, detection of potential cell venting can be provided, as opposed to current sensing methods that focus on detecting cell venting events after they have occurred. This enables contamination or damage of the surroundings of the cell to be avoided, for example during vehicle operation or cell testing. By implementing a deformation detector arranged at a distance from a vent portion, the monitoring can be performed without interfering with the structure and function of the vent portion and hindering its primary safety function, meaning that venting can still occur if necessary.

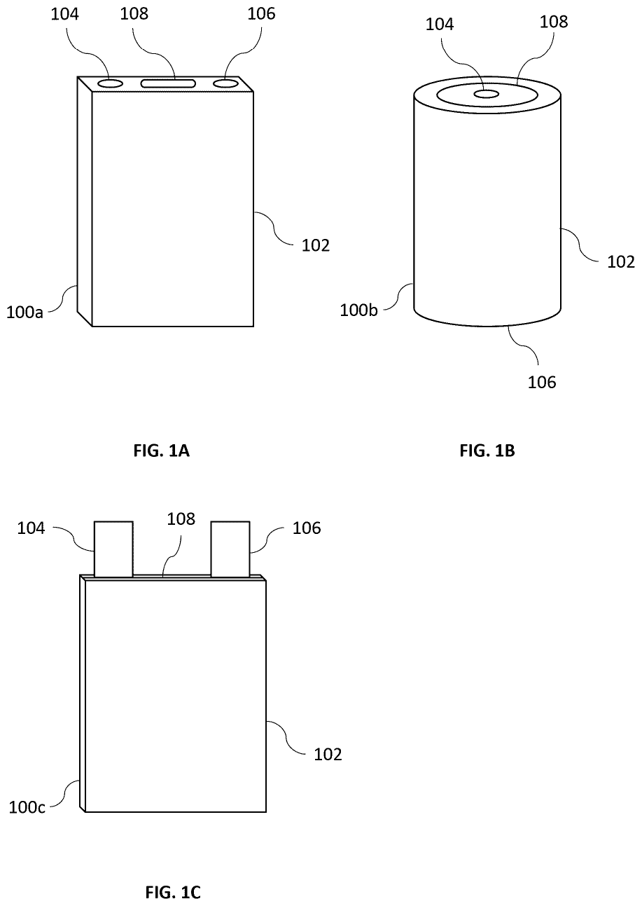

FIGS. 1A to 1C illustrate example battery cells 100. FIG. 1A illustrates a prismatic battery cell 100a, FIG. 1B illustrates a cylindrical battery cell 100b, and FIG. 1C illustrates a pouch battery cell 100c. Such battery cells 100 can be used in battery packs for vehicles, for example for providing power to electric motors and other electrically driven components of the vehicle. Before implementation, the battery cells 100 may be subject to testing, for example in a climate chamber, to observe the behaviour of the cell 100 over time and under different conditions.

Each battery cell 100 comprises a housing 102 configured to enclose components such as electrode rolls and current collecting plates, as known in the art. Each battery cell 100 comprises a positive terminal 104 and a negative terminal 106 for providing electrical connections to the battery cells 100.

Each battery cell 100 also comprises a vent portion 108. The vent portion 108 is configured to break or become detached if the pressure inside the battery cell 100 reaches a threshold value. When this occurs, an opening is provided through which gas and/or other material can be released out of the battery cell 100 to prevent catastrophic failure of the cell 100. In FIGS. 1A to 1C, the vent portions 108 are provided on an end side of the battery cells 100 comprising one or more of the electrical terminals 104, 106, but it will be appreciated that the vent portion 108 can be located at any suitable part of the cell 100, for example to ensure that discharged material is directed away from sensitive components.

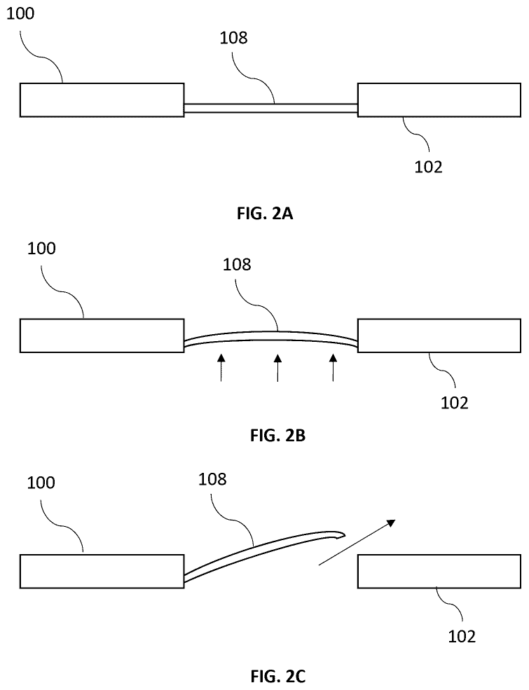

FIGS. 2A to 2C schematically show cross-sectional views of an example battery cell 100 undergoing venting. In particular, FIGS. 2A to 2C show a cross-section of the top of the prismatic cell 100a shown in FIG. 1A, although it will be appreciated that the same principles apply to any type of battery cell 100 shown in FIGS. 1A to 1C.

In FIG. 2A, the battery cell 100 is undergoing normal operation, and the vent portion 108 is in a resting position as the pressure in the cell 100 is at a normal level. In FIG. 2B, the pressure is the battery cell 100 has increased, for example due to a malfunction in the cell 100 such as thermal runaway. As shown in FIG. 2B, the vent portion 108 has been deformed by the increase in pressure inside the battery cell 100. This may occur suddenly or gradually over the life span of the battery cell 100. In FIG. 2C, the pressure is the battery cell 100 has increased to a threshold level at which the vent portion 108 becomes detached from the housing 102. There are various mechanisms by which a vent portion 108 of a battery cell 100 may function that are known in the art and will not be discussed in detail here. Gas and other material from inside the housing 102 of the battery cell 100 is then able to escape. As discussed above, the released material may be hazardous or toxic, and may cause damage or contamination of surrounding components.

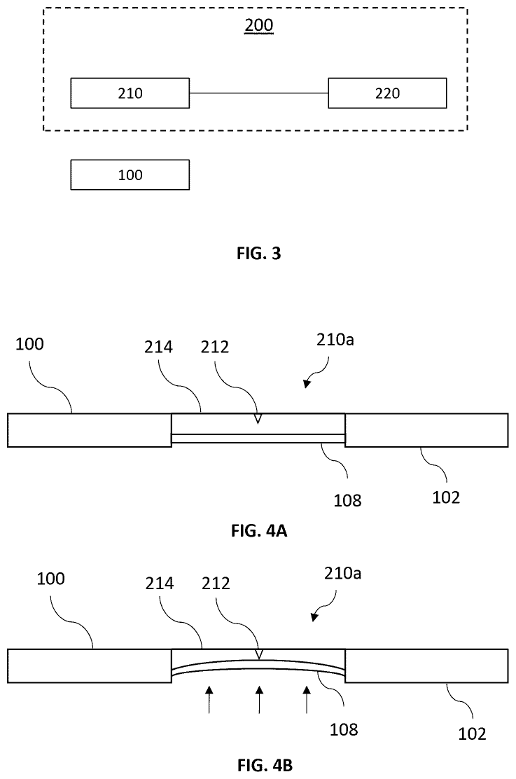

In order to provide early detection of potential cell venting, a system 200 is provided as shown in FIG. 3. The system comprises a deformation detector 210 associated with a battery cell 100 and processing circuitry 220 configured to determine if a deformation detected by the deformation detector 210 meets a threshold deformation.

The deformation detector 210 is configured to be arranged at a distance from a vent portion 108 of the battery cell 100 when the vent portion 108 is in a non-deformed position, and is configured to determine when the vent portion 108 is being deformed by increased pressure inside the battery cell 100 (as shown in FIG. 2B). The deformation detector 210 will be explained in more detail in relation to FIGS. 4 to 8.

The deformation detector 210 is communicably connected to the processing circuitry 220 such that a detection signal can be provided from the deformation detector 210 to the processing circuitry 220. The connection may be a wired, wireless, or network connection, as known in the art. The processing circuitry 220 may be located locally to or remotely from the deformation detector 210. For example, the processing circuitry 220 may be part of a battery management system (BMS) of a vehicle or a test facility, or may be integrated with the deformation detector.

The processing circuitry 220 is configured to determine if a deformation detected by the deformation detector 210 meets a threshold deformation. The threshold deformation can be set to correspond to a deformation of the vent portion 108 that is less than a deformation required for venting of the battery cell 100. In this way, it can be determined that the vent portion 108 is being deformed and action can be taken before venting occurs.

The threshold deformation can be determined in terms of the inner pressure of the battery cell 100 and a shape change of the vent portion 108. This can be determined based on experimental or model data. For example, a threshold deformation could be determined by increasing the pressure in the cell 100 (e.g. by gas injection to a model cell) or by mechanical simulation of a specific pressure on the vent portion 108, and monitoring the behavior of the vent portion 108, i.e. determining a maximum deformation before the vent portion 108 breaks or detaches. This enables thresholds to be determined accurately for specific use cases.

In some examples, the system 200 may further comprise a sensor disposed on the vent portion 108. For example, the system 200 may comprise at least one of a pressure sensor or a strain gauge disposed on the vent portion 108. This provides a redundancy in the system 210, for example in case the deformation detector 210 malfunctions. However, such solutions may potentially interfere with the primary safety function of the vent portion 108 by hindering movement of the vent portion 108.

The system 200 shown in FIG. 3 enables vent deformation to be monitored throughout the life span of a battery cell 100. This provides for early detection of potential cell venting which enables action to be taken to protect battery packs and test facilities from contamination or damage due to cell venting. By implementing a deformation detector arranged at a distance from a vent portion, the monitoring can be performed without interfering with the structure and function of the vent portion and hindering its primary safety function, meaning that venting can still occur if necessary. As another advantage, deformation of a vent portion could be used as an indicator to replace aged cells by determining a cell aging state from the monitored deformation.

Examples of different deformation detectors 210 are shown in FIGS. 4 to 8. As discussed above, the deformation detectors 210 are configured to be arranged at a distance from a vent portion 108 of the battery cell 100 when the vent portion 108 is in a non-deformed position. The deformation detectors 210 are configured to determine when the vent portion 108 is being deformed by increased pressure inside the battery cell 100.

FIGS. 4A and 4B schematically show cross-sectional views of a first example deformation detector 210a of a system for monitoring a battery cell 100. The deformation detector 210a comprises a contact sensor 212 arranged on a support 214. The contact sensor 212 may comprise a sensor for surface roughness monitoring, a strain gauge, or any suitable type of contact sensor for monitoring deformation of the vent portion 108. The deformation detector 210a, and in particular the contact sensor 212, is arranged at a distance from the vent portion 108 of the battery cell 100 when the vent portion 108 is in the non-deformed position, as shown in FIG. 4A. Whilst the contact sensor 212 is shown having a profile extending below the support 214, this is for illustration purposes only and it will be appreciated that the contact sensor could have a smaller profile, or even be flush with the lower surface of the support 214, as long as it is capable of detecting contact.

As shown in FIG. 4B, when the vent portion 108 is in a sufficiently deformed position, the contact sensor 212 contacts the vent portion 108. The contact sensor 212 is therefore enabled to detect a deformation of the vent portion 108. The detected deformation can then be transmitted to the processing circuitry 220, which can compare the deformation to a threshold deformation, as described in relation to FIG. 3.

In one example, the distance between the deformation detector 210a, in particular the contact sensor 212, and the vent portion 108 when the vent portion 108 is in the non-deformed position corresponds to the threshold deformation. In this way, when the vent portion 108 undergoes a deformation of a sufficient distance to contact the contact sensor 212, it can be immediately determined that the vent portion 108 has undergone a deformation at or above the threshold deformation and a corresponding action can be taken.

In another example, the distance between the deformation detector 210a, in particular the contact sensor 212, and the vent portion 108 when the vent portion 108 is in the non-deformed position may be less than the threshold deformation. In this way, a tolerance may be provided for detection of the deformation, which can ensure that false negative determinations are avoided. The contact sensor 212 may be a pressure sensor, and the processing circuitry 220 may use the pressure at the non-deformed position of the vent portion 108 as a zero-level for detecting the deformation. The measured pressure can then be correlated with a deformation distance, enabling the threshold deformation to be detected.

The contact sensor 212 shown in FIG. 4A is disposed in a position substantially corresponding to the centre of the vent portion 108. Due to the structure of the vent portion 108 and its attachment to the housing 102, this is likely to be the position where the most deformation occurs. However, it will be appreciated that the contact sensor 212 could be attached in any suitable position along the length of the support 214 in order to correspond to different positions of the vent portion 108, for example dependent on how the vent portion 108 is structured and configured to operate. In particular, the contact sensor 212 may be disposed in a position substantially corresponding to the position of expected maximum deformation of the vent portion 108.

The support 214 may be a disc, plate, or arm configured to hold the contact sensor 212 in a given position. The support 214 shown in FIG. 4A is attached to the housing 102 of the battery cell 100. This provides an integrated design for a battery cell 100 and deformation detector 210a. It will be appreciated that the support 214 could be attached to another part of a battery pack or test environment that maintains the contact sensor 212 at a distance from the non-deformed position of the vent portion 108. For example, any suitable design of the cap assembly or module top cover of the battery cell 100 may be employed. The support 214 can be configured to enable venting from the vent portion 108 (i.e. it is configured not to block the discharge of material from the vent portion 108), such that it does not hinder the primary safety function of the vent portion 108. This could be achieved in a number of ways, for example by providing a thin support arm or providing holes in a support plate or disc.

It will also be appreciated that, as the vent portion 108 can be located at any suitable part of the battery cell 100 as discussed above, for example to ensure that discharged material is directed away from sensitive components in the area surrounding the battery cell 100, the deformation detector 210 may be located at any suitable corresponding location.

FIGS. 5A and 5B schematically show cross-sectional views of a second example deformation detector 210b of a system for monitoring a battery cell 100. As shown in FIG. 5A, the deformation detector 210b comprises a plurality of contact sensors 212 arranged at different locations on the support 214. Similarly to FIG. 4A, the deformation detector 210b, and in particular the contact sensors 212, is arranged at a distance from the vent portion 108 of the battery cell 100 when the vent portion 108 is in the non-deformed position. The distance between the deformation detector 210b, in particular the contact sensors 212, and the vent portion 108 when the vent portion 108 is in the non-deformed position may correspond to a threshold deformation or may be less than the threshold deformation, as discussed above.

As shown in FIG. 5B, when the vent portion 108 is in a sufficiently deformed position, one or more of the contact sensors 212 contact the vent portion 108. The contact sensors 212 are therefore enabled to detect a deformation of the vent portion 108. By implementing a plurality of contact sensors 212 arranged at different locations, irregular or unpredictable deformation of the vent portion 108 can be detected. It will be appreciated that the plurality of contact sensors 212 can be arranged in any suitable form on the support 214, for example in a line, a circle, a pattern, and the like, dependent on the structure of the support 214 or the expected points of deformation of the vent portion 108. Whilst seven non-contact sensors 212 are shown, it will be appreciated that any suitable number of contact sensors 212 may be provided.

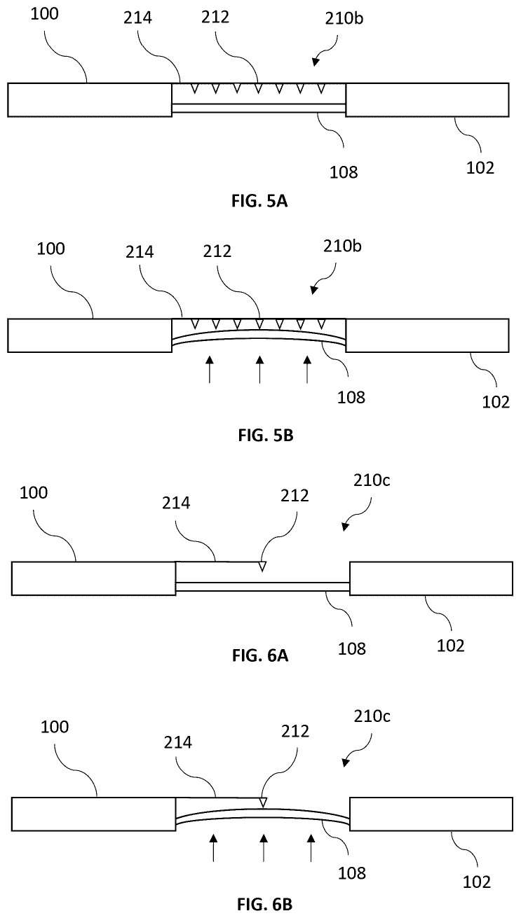

FIGS. 6A and 6B schematically show cross-sectional views of a third example deformation detector 210c of a system for monitoring a battery cell 100. As shown in FIG. 6A, the deformation detector 210c comprises a contact sensor 212 arranged on a cantilevered support 214. This enables the arrangement of a deformation detector that does not interfere with the structure and function of the vent portion 108, as the support only extends in one direction from the contact sensor 212. Similarly to FIGS. 4A and 5A, the deformation detector 210c, and in particular the contact sensor 212, is arranged at a distance from the vent portion 108 of the battery cell 100 when the vent portion 108 is in the non-deformed position, which may correspond to a threshold deformation or may be less than the threshold deformation.

As shown in FIG. 6B, when the vent portion 108 is in a sufficiently deformed position, the contact sensor 212 contacts the vent portion 108. The contact sensor 212 is therefore enabled to detect a deformation of the vent portion 108. In the case that action is not taken in sufficient time to prevent venting, the structure of the deformation detector 210c enables the vent portion to break or become detached from the housing 102 to enable pressure to be released, as shown in FIG. 2C.

Similarly to FIG. 4A, the contact sensor 212 shown in FIG. 6A is disposed in a position corresponding substantially to the centre of the vent portion 108, although it will be appreciated that the contact sensor 212 could be attached in any suitable position along the length of the support 214. The support 214 may be a plate or arm configured to hold the contact sensor 212 in a given position in a cantilevered form.

The support 214 shown in FIG. 6A is attached to the housing 102 of the battery cell 100. This provides an integrated design for a battery cell 100 and deformation detector 210c. It will be appreciated that the support 214 could be attached to another part of a battery pack or test environment that maintains the contact sensor 212 at a distance from the non-deformed position of the vent portion 108. For example, any suitable design of the cap assembly or module top cover of the battery cell 100 may be employed.

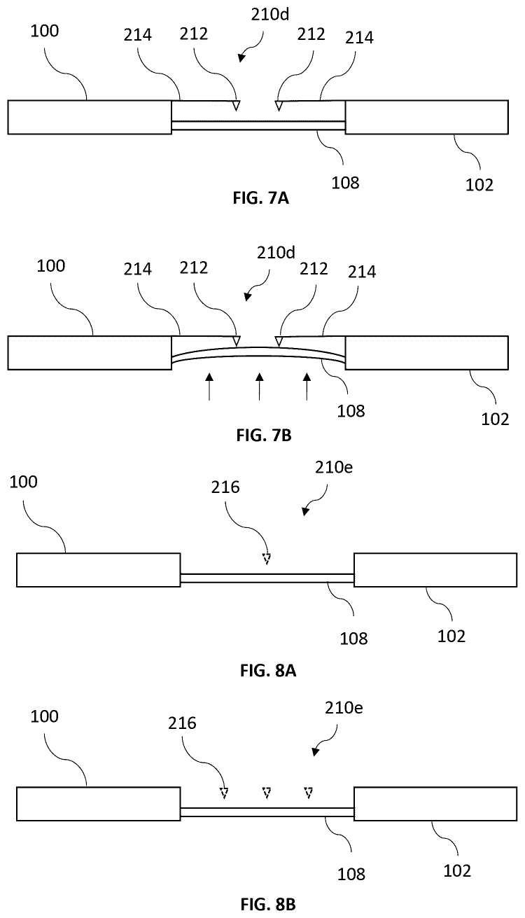

FIGS. 7A and 7B schematically show cross-sectional views of a fourth example deformation detector 210d of a system for monitoring a battery cell 100. As shown in FIG. 7A, the deformation detector 210c comprises a plurality of contact sensors 212 arranged on respective cantilevered supports 214. Similarly to FIGS. 4A, 5A, and 6A, the deformation detector 210d, and in particular the contact sensors 212, are arranged at a distance from the vent portion 108 of the battery cell 100 when the vent portion 108 is in the non-deformed position, which may correspond to a threshold deformation or may be less than the threshold deformation.

As shown in FIG. 7B, when the vent portion 108 is in a sufficiently deformed position, one or more of the contact sensors 212 contact the vent portion 108. The contact sensors 212 are therefore enabled to detect a deformation of the vent portion 108. By implementing a plurality of contact sensors 212 arranged at different locations, irregular or unpredictable deformation of the vent portion 108 can be detected. Whilst two contact sensors 212 and cantilevered supports 214 are shown, it will be appreciated that any suitable number of contact sensors 212 and cantilevered supports 214 may be provided, and each support may be provided with more than one contact sensor 212.

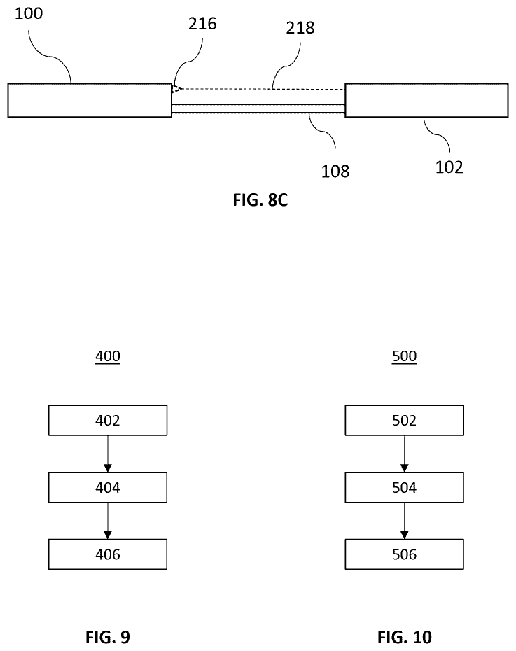

FIGS. 8A to 8C schematically show cross-sectional views of a fifth example deformation detector 210e of a system for monitoring a battery cell 100. In these examples, the deformation detector 210e comprises a non-contact sensor 216, illustrated in dashed lines. The non-contact sensor 216 may be mounted at any suitable position relative to the battery cell 100 that enables it to detect a deformation of the vent portion 108. For example, the non-contact sensor 216 may be mounted to the housing 102 of the battery cell 100, or to another part of a battery pack or test environment. For example, any suitable design of the cap assembly or module top cover of the battery cell 100 may be employed. By using a non-contact sensor 216, deformation of the vent portion 108 may be detected without interfering at all with the structure or function of the vent portion 108, and the sensor may be positioned at any suitable distance from the vent portion 108, increasing the flexibility of the implementation of the deformation detector 210e.

The non-contact sensor 216 may comprise an optical sensor or a laser sensor capable of detecting a deformation of the vent portion 108 without contacting the vent portion 108. The selection of a type of non-contact sensor 216 enables different devices to be used, for example in implementations requiring different levels of precision. Similarly to FIGS. 4A and 6A, the non-contact sensor 216 shown in FIG. 8A is disposed in a position corresponding substantially to the centre of the vent portion 108, although it will be appreciated that the contact sensor 212 could be attached in any suitable position relative to the vent portion 108.

As shown in FIG. 8B, the deformation detector 210e comprises a plurality of non-contact sensors 216 arranged at different locations relative to the vent portion 108. By implementing a plurality of non-contact sensors 216 arranged at different locations, irregular or unpredictable deformation of the vent portion 108 can be detected. It will be appreciated that the plurality of non-contact sensors 216 can be arranged in any suitable form, for example in a line, a circle, a pattern, and the like, dependent on the expected points of deformation of the vent portion 108. Whilst three non-contact sensors 216 are shown, it will be appreciated that any suitable number of non-contact sensors 216 may be provided.

FIG. 8C shows an example where substantially the entire surface of the vent portion 108 can be monitored, for example by an optical sensor or a laser sensor. In this example, the non-contact sensor 216 may be arranged to monitor the vent portion 108 in a transverse direction 218 with respect to the battery call 100, in order to detect deformation of the vent portion 108 in a longitudinal direction.

Deformation detectors 210 such as the deformation detectors 210a-e shown in FIGS. 4 to 8 enable early detection of potential venting of a battery cell 100 without interfering with the structure and function of the vent portion 108 and hindering its primary safety function. It will be appreciated that the deformation detectors 210a-e shown in FIGS. 4 to 8 could be combined in any suitable manner. For example, a deformation detector 210 may comprise any suitable number of contact sensors 212 and/or non-contact sensors 216 arranged in any suitable configuration.

In the case that a single contact sensor 212 or non-contact sensor 216 is used, the value measured by that sensor may be compared to the threshold deformation. If the value meets or is above the threshold, an action can be taken to prevent venting. In the case that a plurality of contact sensors 212 and/or non-contact sensors 216 are used, one, several or all of the values measured by the sensors may be compared to the threshold. For example, it may be determined that, for an action to be taken to prevent venting, only one sensor needs to detect a sufficiently large deformation. Alternatively, it may be determined that a subset of the sensors, for example two or more sensors, need to detect a sufficiently large deformation for an action to be taken to prevent venting. Alternatively, it may be determined that all of the sensors need to detect a sufficiently large deformation for an action can be taken to prevent venting. It may also be possible that different thresholds are used for different sensors. For example, different parts of the vent portion 108 may be allowed to undergo more deformation than others, and respective thresholds can be set accordingly.

FIG. 9 is a flow chart of a method 400 for monitoring a battery cell 100. The method 400 may be performed by the system 200 described in relation to FIG. 3.

At 402, a deformation of a vent portion 108 of the battery cell 100 is determined. The deformation is determined by a deformation detector 210, such as one of the deformation detectors 210 described in relation to FIGS. 4 to 8. The deformation detector 210 is arranged at a distance from the vent portion 108. In some examples, the deformation is determined using at least one contact sensor 212 of the deformation detector 210. In some examples, the deformation is determined using at least one non-contact sensor 216 of the deformation detector 210.

At 404, it is determined if the detected deformation meets a threshold deformation. The determination is performed using the processing circuitry 220. The determination of the threshold may be performed in the manner discussed above.

At 406, if it is determined that the detected deformation meets the threshold deformation, an action is taken to prevent venting of the battery cell 100. In one example, the action comprises electrically disconnecting the battery cell 100 to avoid further malfunction of the cell 100.

The method 400 enables early detection of potential cell venting, which ensures that action can be taken before potentially dangerous material is discharged from the battery cell 100 and causes damage or contamination of surrounding parts of a battery pack or test facility. This can be performed without interfering with the structure of the vent portion 108 of the battery cell 100 and hindering its primary safety function. As another advantage, deformation of a vent portion 108 could be used as an indicator to replace aged cells by determining a cell aging state from the monitored deformation.

FIG. 10 is a flow chart of a method 500 for monitoring a battery cell 100. The method 500 may be performed by the processing circuitry 220 of the system 200 described in relation to FIG. 3.

At 502, a signal representing deformation of a vent portion 108 of the battery cell 100 is received. The signal may be received from a deformation detector 210 configured to determine the deformation, such as one of the deformation detectors 210 described in relation to FIGS. 4 to 8.

At 504, it is determined if the detected deformation meets a threshold deformation. The determination of the threshold may be performed in the manner discussed above.

At 506, if it is determined that the detected deformation meets the threshold deformation, an action is taken to prevent venting of the battery cell 100. In one example, the action comprises sending a signal to electrically disconnect the battery cell 100 to avoid further malfunction of the cell 100.

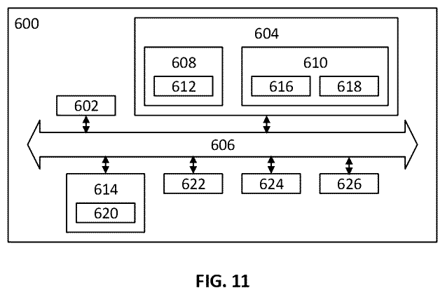

FIG. 11 is a schematic diagram of a computer system 600 for implementing examples disclosed herein. The computer system 600 is adapted to execute instructions from a computer-readable medium to perform these and/or any of the functions or processing described herein. The computer system 600 may be connected (e.g., networked) to other machines in a LAN, an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include processing circuitry 602 (e.g., processing circuitry including one or more processor devices or control units), a memory 604, and a system bus 606. The computer system 600 may include at least one computing device having the processing circuitry 602. The system bus 606 provides an interface for system components including, but not limited to, the memory 604 and the processing circuitry 602. The processing circuitry 602 may include any number of hardware components for conducting data or signal processing or for executing computer code stored in memory 604. The processing circuitry 602 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 602 may further include computer executable code that controls operation of the programmable device. The processing circuitry 220 of the system 200 may be embodied by the processing circuitry 602.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the processing circuitry 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with processing circuitry 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program 620 stored on a transitory or non-transitory computer-usable or computer-readable storage medium (e.g., single medium or multiple media), such as the storage device 614, which includes complex programming instructions (e.g., complex computer-readable program code) to cause the processing circuitry 602 to carry out actions described herein. Thus, the computer-readable program code of the computer program 620 can comprise software instructions for implementing the functionality of the examples described herein when executed by the processing circuitry 602. In some examples, the storage device 614 may be a computer program product (e.g., readable storage medium) storing the computer program 620 thereon, where at least a portion of a computer program 620 may be loadable (e.g., into a processor) for implementing the functionality of the examples described herein when executed by the processing circuitry 602. The processing circuitry 602 may serve as a controller or control system for the computer system 600 that is to implement the functionality described herein.

The computer system 600 may include an input device interface 622 configured to receive input and selections to be communicated to the computer system 600 when executing instructions, such as from a keyboard, mouse, touch-sensitive surface, etc. Such input devices may be connected to the processing circuitry 602 through the input device interface 622 coupled to the system bus 606 but can be connected through other interfaces, such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may include a communications interface 626 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:
Example 1. A system (200) for monitoring a battery cell (100), the system comprising:
   a deformation detector (210) configured to be arranged at a distance from a vent portion (108) of the battery cell when the vent portion is in a non-deformed position and to detect a deformation of the vent portion; and
   processing circuitry (220) for determining if the detected deformation meets a threshold deformation.
Example 2. The system (200) of example 1, wherein the deformation detector (210) comprises at least one contact sensor (212) configured to contact the vent portion (108) when the vent portion is in a deformed position.
Example 3. The system (200) of example 2, wherein the at least one contact sensor (212) is disposed in a cantilevered arrangement.
Example 4. The system (200) of example 3, wherein the at least one contact sensor (212) is disposed in a cantilevered arrangement from a housing (102) of the battery cell (100).
Example 5. The system (200) of any of examples 2 to 4, wherein the distance corresponds to the threshold deformation.
Example 6. The system (200) of any preceding example, wherein the deformation detector (210) comprises at least one non-contact sensor (216) configured to detect a deformation of the vent portion.
Example 7. The system (200) of example 6, wherein the non-contact sensor (216) comprises an optical sensor or a laser sensor.
Example 8. The system (200) of any of examples 2 to 7, wherein the deformation detector (210) comprises a plurality of sensors (212, 216)
Example 9. The system (200) of any preceding example, wherein the threshold deformation corresponds to a deformation of the vent portion (108) less than a deformation required for venting of the battery cell (100).
Example 10. The system (200) of any preceding example, wherein the threshold deformation is determined based on experimental or model data.
Example 11. The system (200) of any preceding example, wherein the threshold deformation comprises a plurality of threshold deformations.
Example 12. The system (200) of any preceding example, wherein the vent portion (108) is provided on an end side of the battery cell (100) comprising one or more electrical terminals.
Example 13. The system (200) of any preceding example, wherein the battery cell (100) is a prismatic cell, a cylindrical cell, or a pouch cell.
Example 14. The system (200) of any preceding example, wherein the battery cell (100) is comprised in a battery pack for a vehicle.
Example 15. A vehicle comprising the system (200) of any preceding claim.
Example 16. The system (200) of any of examples 1 to 14, wherein the battery cell (100) is in a test environment.
Example 17. A method (400) for monitoring a battery cell (100), the method comprising:
   determining (402) a deformation of a vent portion (108) of the battery cell at a deformation detector (210) arranged at a distance from a vent portion; and
   determining (404) if the detected deformation meets a threshold deformation.
Example 18. The method (400) of example 17, comprising determining the deformation using at least one contact sensor (212) of the deformation detector (210).
Example 19. The method (400) of example 17 or 18, comprising determining the deformation using at least one non-contact sensor (216) of the deformation detector (210).
Example 20. The method (400) of any of examples 17 to 19, further comprising taking an action (406) to prevent venting of the battery cell (100) in response to determining (404) that the detected deformation meets the threshold deformation.
Example 21. The method (400) of example 20, wherein taking an action (406) comprises electrically disconnecting the battery cell (100).
Example 22. A computer-implemented method (500) comprising, by processing circuitry of a computer system:
   receiving (502) a signal representing a deformation of a vent portion (108) of the battery cell from a deformation detector (210) arranged at a distance from a vent portion; and
   determining (504) if the detected deformation meets a threshold deformation.
Example 23. The computer-implemented method (500) of example 22, further comprising taking an action (506) to prevent venting of the battery cell (100) in response to determining (504) that the detected deformation meets the threshold deformation, for example sending a signal to electrically disconnect the battery cell (100).

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or

“vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A system for monitoring a battery cell, the system comprising:
a deformation detector configured to be arranged at a distance from a vent portion of the battery cell when the vent portion is in a non-deformed position and to detect a deformation of the vent portion, wherein the deformation detector comprises at least one contact sensor disposed in a cantilevered arrangement and configured to contact the vent portion when the vent portion is in a deformed position; and
processing circuitry for determining if the detected deformation meets a threshold deformation.

2. The system of claim 1, wherein the distance corresponds to the threshold deformation.

3. The system of claim 1, wherein the deformation detector comprises at least one non-contact sensor configured to detect a deformation of the vent portion.

4. The system of claim 3, wherein the non-contact sensor comprises an optical sensor or a laser sensor.

5. The system of claim 1, wherein the deformation detector comprises a plurality of sensors.

6. The system of claim 1, wherein the threshold deformation corresponds to a deformation of the vent portion less than a deformation required for venting of the battery cell.

7. The system of claim 1, wherein the threshold deformation comprises a plurality of threshold deformations.

8. A vehicle comprising the system of claim 1.

9. A method for monitoring a battery cell, the method comprising:
determining a deformation of a vent portion of the battery cell at a deformation detector arranged at a distance from a vent portion, wherein the deformation detector comprises at least one contact sensor disposed in a cantilevered arrangement and configured to contact the vent portion when the vent portion is in a deformed position; and
determining if the detected deformation meets a threshold deformation.

10. The method of claim 9, further comprising determining the deformation using at least one non-contact sensor of the deformation detector.

11. The method of claim 9, further comprising taking an action to prevent venting of the battery cell in response to determining that the detected deformation meets the threshold deformation.

12. The method of claim 11, wherein taking an action comprises electrically disconnecting the battery cell.
